(19) United States
(12) Patent Application Publication
(10) Pub. No.: US 2014/0195323 A1
(43) Pub. Date: Jul. 10, 2014

(54) WEBSITE AND MOBILE APP FOR SHOPPING LIST PRICE COMPARISON

(71) Applicant: FUJITSU LIMITED, Kawasaki-shi (JP)

(72) Inventor: Linh HANKINS, Milpitas, CA (US)

(73) Assignee: FUJITSU LIMITED, Kawasaki-shi (JP)

(21) Appl. No.: 13/734,736

(22) Filed: Jan. 4, 2013

(51) Int. Cl. G06Q 30/06

(52) U.S. Cl. CPC G06Q 30/0633
USPC 705/14.27; 705/26.8; 705/14.39

(57) ABSTRACT

A method of pricing a shopping list includes receiving input effective to generate a shopping list identifying multiple different items. The method also includes identifying pricing data of the different items, the pricing data including: a unit cost of each of the different items at multiple different locations, each of the different locations being associated with a different one of multiple merchants; and discounts applicable to one or more of the different items. The method also includes generating a comparison table based on the pricing data. The comparison table includes a price comparison of the shopping list between the merchants.

### FIELD

The embodiments discussed herein are related to a website and mobile app for shopping list price comparison.

### BACKGROUND

Purchasing groceries is a time-consuming task for many people. In addition to the time spent purchasing the groceries, people often spend additional time creating shopping lists, finding and organizing coupons, searching for sales, and performing other grocery-related tasks.

Various websites, apps, and/or other solutions enable users to manage various aspects of the foregoing tasks. For example, some solutions allow users to create and organize shopping lists. Other solutions allow users to find or receive coupons. Still other solutions allow users to compare prices for a single item between a local brick and mortar store versus an online store.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of pricing a shopping list includes receiving input effective to generate a shopping list identifying multiple different items. The method also includes identifying pricing data of the different items, the pricing data including: a unit cost of each of the different items at multiple different locations, each of the different locations being associated with a different one of multiple merchants; and discounts applicable to one or more of the different items. The method also includes generating a comparison table based on the pricing data. The comparison table includes a price comparison of the shopping list between the merchants.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which a shopping list application may be implemented;

FIG. 2A shows an example flow diagram of a method that may be implemented in the operating environment of FIG. 1;

FIG. 2B shows an example embodiment of a comparison table that may be generated according to the method of FIG. 2A;

FIG. 3 is a block diagram of an example system of pricing a shopping list;

FIG. 4 shows an example flow diagram of a method of pricing a shopping list; and

FIG. 5 is a block diagram illustrating an example computing device that is arranged for pricing a shopping list.

### DESCRIPTION OF EMBODIMENTS

The embodiments discussed herein are related to shopping list price comparison between two or more merchants. Accordingly, a shopping list application implemented as a website and/or a mobile app may be provided. The shopping list application may be configured to generate a shopping list of multiple different items, to identify pricing data for the items at each of multiple different merchants, and to generate a comparison table, including a price comparison of the shopping list between the different merchants.

The comparison table may include a unit cost of the various items at each of the different merchants. Discounts such as coupons, rebates, sales, and/or special offers, including merchant-specific and/or location-specific discounts, may be included in the pricing data and an extended cost for each of the items in the shopping list may be calculated based on the corresponding unit cost and any applicable discounts. Thus, the comparison table presents a customer with a big-picture view of the shopping list where the customer may consider the total cost of all of the items in the shopping list after discounts at each of the different merchants. As a matter of time efficiency, the customer may save at least some money by simply patronizing only one of the merchants, e.g., the one that offers a lowest total cost for the items in the shopping list. To save even more money at the expense of time, the customer may instead patronize a first one of the merchants for some of the items in the shopping list (e.g., those items that are relatively cheaper at the first one of the merchants), a second one of the merchants for other items in the shopping list (e.g., those items that are relatively cheaper at the second one of the merchants), and so on.

In some embodiments, the comparison table additionally accounts for membership of the customer in a customer loyalty program as reflected in the extended cost in the comparison table for any or all of the items in the shopping list with respect to any or all of the merchants.

Alternately or additionally, the comparison table may indicate a donation amount of the total cost for any or all of the merchants towards an entity such as a charity associated with a merchant donation program. The customer may also consider the donation amount and/or the entity when deciding which of the merchants to patronize.

Embodiments of the present invention will be explained with reference to the accompanying drawings.

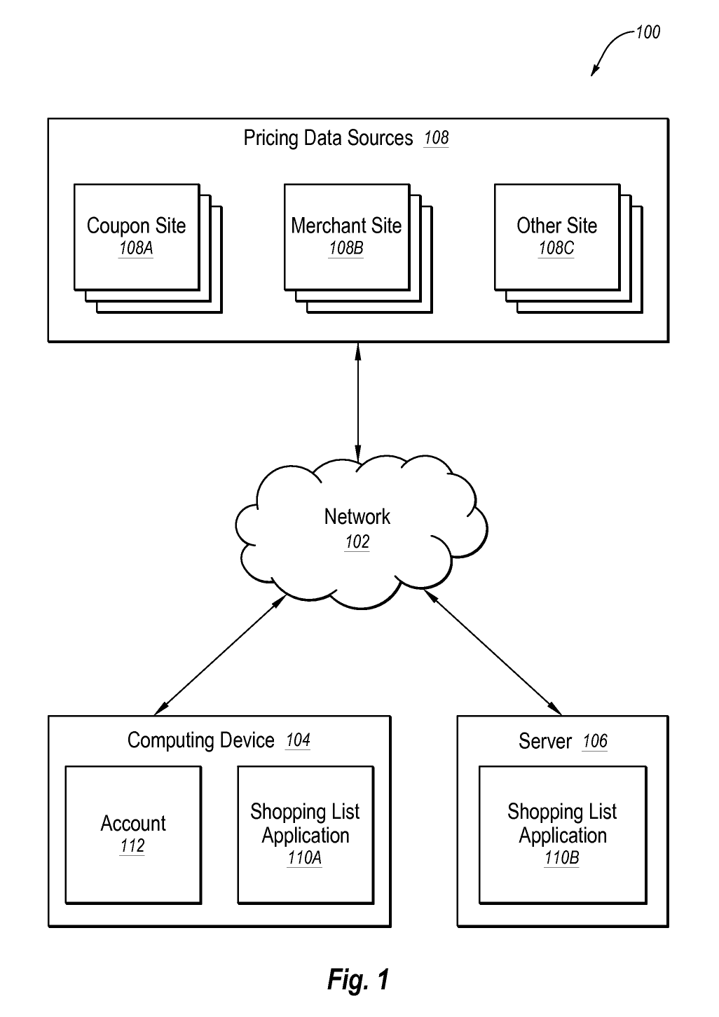

FIG. 1 is a block diagram of an example operating environment 100 in which a shopping list application may be implemented, arranged in accordance with at least one embodiment described herein. The operating environment 100 may include a network 102, a computing device 104, a server 106, and one or more pricing data sources 108.

In general, the network 102 may include one or more wide area networks (WANs) and/or local area networks (LANs) that enable the computing device 104, the server 106, and/or the pricing data sources 108 to communicate with each other. In some embodiments, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

A shopping list application may be provided that, in general, is used to generate a shopping list of multiple different items, to identify pricing data for the items at each of multiple different merchants, and to generate a comparison table, including a price comparison of the shopping list between the different merchants. The shopping list may be generated in response to user input, for example. The shopping list application may have various components which are divided between the computing device 104 and the server 106. For example, as illustrated in FIG. 1, the components of the shopping list application on the computing device 104 are identified as shopping list application 110A, while the components of the shopping list application on the server 106 are identified as shopping list application 110B. The various components are collectively referred to hereinafter as the “shopping list application 110.” Alternately, the shopping list application 110 or equivalent functionality thereof may be provided in its entirety on the computing device 104, in which case the server 106 may be omitted.

The computing device 104 may include, but is not limited to, a desktop computer, a laptop computer, a tablet computer, a mobile phone, a smartphone, a personal digital assistant (PDA), or other suitable computing device. When the computing device 104 is implemented as a mobile device, such as a tablet computer or smartphone, the shopping list application 110A on the computing device 104 may be implemented as an app designed to run on tablet computers, smartphones, or other mobile devices. In these and other embodiments, the shopping list application 110A may communicate through the network 102 with the server 106 to cooperate with the shopping list application 110B to perform one or more of the operations described herein. Alternately or additionally, the shopping list application 110 may be accessed on the computing device 104 via a browser (not shown) that communicates through the network 102 with the server 106 to download therefrom the shopping list application 110A implemented as a runtime script, such as JavaScript, or other suitable program, that is executed in the browser in cooperation with the shopping list application 110B on the server 106 to perform one or more of the operations described herein.

The shopping list application 110 may be configured to obtain pricing data from the pricing data sources 108 to generate the comparison table. The pricing data sources 108 may include, but are not limited to, one or more coupon websites (hereinafter “coupon sites”) 108A, one or more merchant websites (hereinafter “merchant sites”) 108B, and/or one or more other websites (hereinafter “other sites”) 108C. The coupon sites 108A may include websites that specialize in distributing coupons, such as coupons.com, smartsource.com, and valpak.com, to name a few. The merchant sites 108B may include websites associated with different merchants; the different merchants may include grocery stores in some embodiments. The other sites 108C may include websites associated with manufacturers (hereinafter “manufacturer websites”) or other websites.

Other pricing data sources may include an account 112 associated with a customer in which coupons or other discounts are saved by the customer, which account may be stored at the computing device 104 as illustrated in FIG. 1, or at the server 106, and/or other suitable location. The customer may save coupons or other discounts digitally by scanning the coupons or other discounts using the computing device 104, taking a digital photo of the coupons or other discounts using the computing device 104, entering a barcode number or other identifier of the coupons or other discounts into the computing device 104, or the like or any combination thereof. When the computing device 104 is a mobile device and/or in other embodiments, the customer may present the coupons or other discounts to be redeemed at a corresponding merchant at the time of purchase, e.g., by displaying the coupons or other discounts on the computing device 104 and presenting the computing device 104 with the displayed coupons or other discounts to the merchant.

In these and other embodiments, the account 112 of the customer may additionally identify one or more customer loyalty programs associated with the different merchants and to which the customer belongs. In general, membership in a customer loyalty program allows the customer to receive preferential pricing on at least some items sold by a merchant and/or to accrue points that may be used for future purchases or the like. Proof of membership in a customer loyalty program is often provided by presenting a card, key fob, or the like, to the merchant at the time of purchase and/or by providing the merchant with a phone number or other identifying information of the customer. Such identifying information and/or an identification of one or more customer loyalty programs to which the customer belongs may be included in the account 112. Pricing data collected from the pricing data sources 108 and presented in the comparison table may reflect the customer's membership in a corresponding customer loyalty program in some embodiments.

Alternately or additionally, one or more of the merchants may participate in a merchant donation program. In merchant donation programs, merchants commit to donate a certain amount and/or percentage of at least some purchases to an entity such as a charity, a school, or the like. Pricing data collected from the pricing data sources 108 and presented in the comparison table may reflect the participation of one or more of the merchants in a merchant donation program.

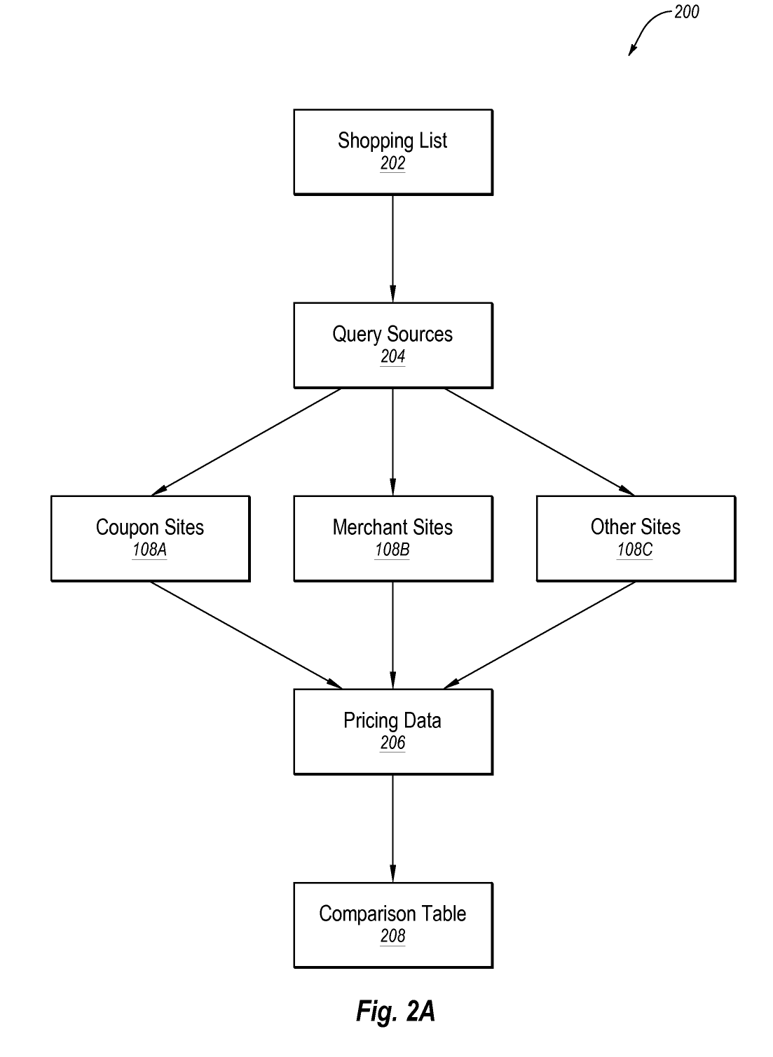

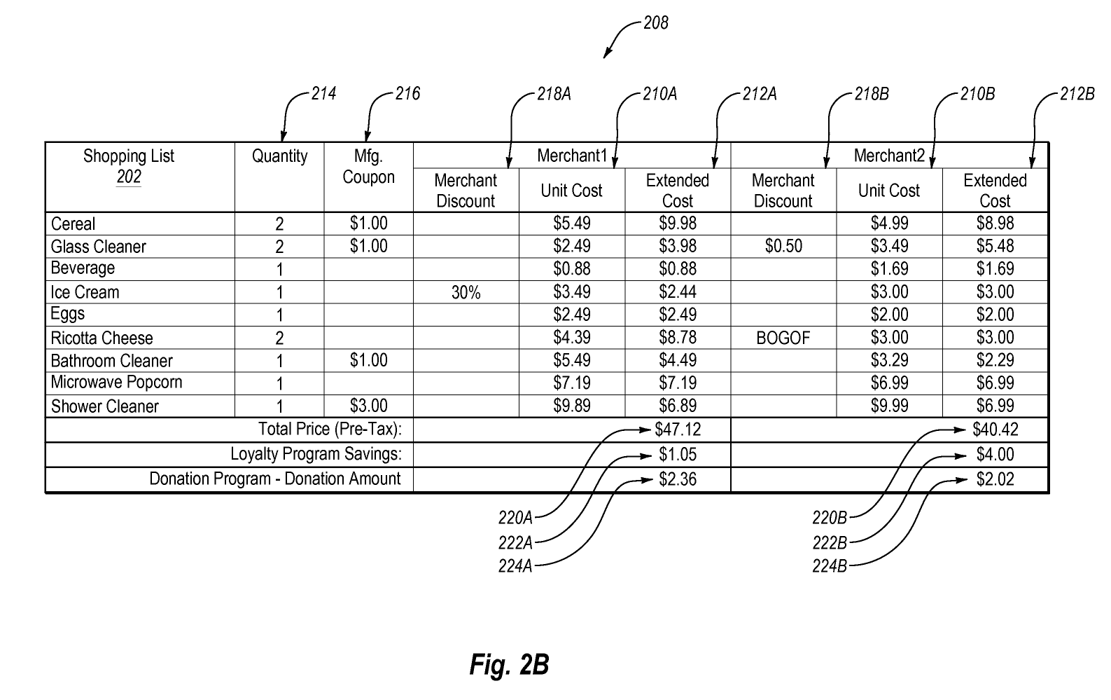

FIG. 2A shows an example flow diagram of a method 200 that may be implemented in the operating environment 100 of FIG. 1, arranged in accordance with at least one embodiment described herein. The method 200 in some embodiments is performed by the computing device 104 and/or the server 106 of FIG. 1, e.g., by execution of the shopping list application 110. Although illustrated as discrete blocks, various blocks may be divided into additional blocks, combined into fewer blocks, or eliminated, depending on the desired implementation.

With combined reference to FIGS. 1-2, the method 200 may include receiving input, such as user input, effective to generate a shopping list 202 that identifies multiple different items. At block 204, various sources, such as pricing data sources 108, are queried to identify pricing data 206 of the items identified in the shopping list 202. Alternately or additionally, the account 112 associated with the customer may be queried for pricing data 206.

The pricing data 206 may include a unit cost of each of the items in the shopping list 202, one or more discounts applicable to one or more items in the shopping list 202, or the like or any combination thereof. Accordingly, querying the merchant sites 108B may return a unit cost of each of the items in the shopping list 202 at each of multiple merchants in some embodiments. The discounts applicable to one or more items in the shopping list 202 may include and/or may be associated with at least one of a coupon, a rebate, a sale, or a special offer. Accordingly, querying the coupon sites 108A and/or the other sites 108C-such as manufacturer websites-may return one or more manufacturer coupons or rebates applicable to one or more of the items in the shopping list 202. Alternately or additionally, querying the merchant sites 108B may return one or more merchant-specific coupons, rebates, sales, special offers, or other discounts applicable to one or more of the items in the shopping list 202.

In addition to pricing data 206, the pricing data sources 108 may return merchant donation program data in some embodiments. For instance, the merchant sites 108B may return an indication or identification of one or more merchant donation programs in which the corresponding merchant participates.

A comparison table 208 may then be generated based on the pricing data 206. In general, the comparison table 208 may include a price comparison of the shopping list 202 between two or more merchants. Alternately or additionally, the comparison table 208 may include a total cost to purchase all of the items on the shopping list 202 at each of multiple merchants, a donation amount to a merchant donation program based on the total cost at a corresponding one of the merchants, discount amounts for one or more of the items in the shopping list, unit cost per item in the shopping list 202, or the like or any combination thereof.

FIG. 2B shows an example embodiment of the comparison table 208 that may be generated according to the method 200 of FIG. 2A, arranged in accordance with at least one embodiment described herein. In the illustrated embodiment, the comparison table 208 includes the shopping list 202 including various items, such as cereal, glass cleaner, a beverage, etc. The various items are identified generically in FIG. 2B; in practice, however, the shopping list 202 may alternately or additionally identify the particular brand, type, size, and/or other identifying features of the items. For instance, in practice, the first line of the shopping list 202 may include “Cheerios®, 18 oz. box” or other specific brand/type/size of cereal rather than simply the more generic “Cereal” illustrated in FIG. 2B. As another example, in practice, the second line of the shopping list 202 may include “Windex® Glass Cleaner, 32 oz. spray bottle” or other specific brand/type/size of glass cleaner rather than simply the more generic “Glass Cleaner” illustrated in FIG. 2B.

The comparison table 208 may additionally include a price comparison of the shopping list 202 between at least a first merchant, Merchant1, and a second merchant, Merchant2. In particular, the comparison table 208 may include a unit cost column 210A, 210B that lists a unit cost of each of the items in the shopping list 202 at each of Merchant1 and Merchant2, and an extended cost column 212A, 212B that lists an extended cost of each of the items in the shopping list 202 at each of Merchant1 and Merchant2. Thus, the comparison table 208 compares the cost of multiple items at multiple merchants simultaneously. Although the comparison table 208 includes a price comparison for two merchants in the illustrated embodiment, more generally the comparison table 208 may include a price comparison for two or more merchants.

In these and other embodiments, the extended cost for each item in the extended cost columns 212A, 212B may be based, at least in part, on a quantity of the item and a unit cost of the item. For example, in some embodiments, the extended cost for each item is calculated according to EC=QTY×UC−D, where EC is the extended cost of the item, QTY is a quantity of the item, UC is the unit cost of the item, and D is a discount, if any, applicable to the item.

Accordingly, the comparison table 208 may additionally include a quantity column 214, a manufacturer's coupon column 216, and/or one or more merchant discount columns 218A, 218B in some embodiments.

The quantity column 214 may include a desired quantity of each of the items in the shopping list 202. The desired quantity may be input by the customer when the items in the shopping list 202 themselves are input by the customer.

The manufacturer's coupon column 216 may include a value or other indication of one or more manufacturer's coupons, rebates, or other discounts applicable to at least some of the items in the shopping list. For instance, the manufacturer's coupon column 216 includes a value of $1.00 off for each of the first, second, and seventh items in the shopping list 202 and a value of $3.00 off for the last item in the shopping list 202. If no manufacturer's coupons are returned in response to querying the corresponding sources, the manufacturer's coupon column 216 may be empty.

Each of the merchant discount columns 218A, 218B may include a value or other indication of one or more merchant discounts applicable to at least some of the items in the shopping list. For example, the merchant discount column 218A associated with Merchant1 includes a value of 30% off for the fourth item in the shopping list 202. As another example, the merchant discount column 218B associated with Merchant2 includes a value of $0.50 off for the second item in the shopping list 202 and an indication that the sixth item in the shopping list 202 is subject to a special deal at Merchant2 of buy-one-get-one-free (BOGOF). If no merchant discounts are returned in response to querying the corresponding sources, the merchant discount columns 218A, 218B may be empty.

Some merchants have multiple different locations, meaning that a given merchant may have a store in each of the multiple different locations. For example, merchants such as WALMART have stores in a variety of different locations. The various stores of the same merchant at different locations may be referred to herein as “merchant locations.” In these and other embodiments, the merchant discounts in the corresponding merchant discount column 218A, 218B of the comparison table 208 may be applicable at all merchant locations of Merchant1 or Merchant2 or only at select merchant locations. Accordingly, the customer may provide or select a location of the customer or the location of the customer may otherwise be determined and may be used to identify which of multiple merchant locations of Merchant1 or Merchant2 to consider when collecting the pricing data 206 of FIG. 2A.

By definition, merchant discounts are generally limited to use at a corresponding merchant and not at other merchants. In contrast, manufacturer's discounts, such as manufacturer's coupons, may typically be redeemed at many different merchants. Accordingly, and as illustrated in FIG. 2B, the comparison table 208 may separate manufacturer's coupons or other manufacturer's discounts in, e.g., the manufacturer's coupon column 216, from merchant discounts, e.g., in the merchant discount columns 218A, 218B.

FIG. 2B additionally illustrates that each item in the shopping list 202 may not have any associated discounts, may have only an associated manufacturer's coupon, may have only an associated merchant discount, or may have both an associated manufacturer's coupon and an associated merchant discount.

The comparison table 208 may additionally include a total cost 220A to purchase all of the items in the shopping list 202 from Merchant1 and a total cost 220B to purchase all of the items in the shopping list 202 from Merchant2. The total costs 220A, 220B may omit any applicable sales tax, or the applicable sales tax may be included in the total costs 220A, 220B. Alternately or additionally, the pre-tax total, the amount of tax, and the post-tax total may be listed for each of Merchant1 and Merchant2 in the comparison table 208.

As mentioned previously, the customer's membership in one or more customer loyalty programs may be reflected in the pricing data 206 obtained from the pricing data sources 108 and/or in the comparison table 208. A total loyalty program savings resulting from membership in respective customer loyalty programs for Merchant1 and Merchant2 may be reflected at 222A, 222B, for instance. In some embodiments, the unit cost per item in the unit cost columns 210A, 210B includes a relatively lower amount when the customer belongs to a corresponding customer loyalty program than when the customer does not belong to the customer loyalty program. Alternately or additionally, the merchant discounts included in the merchant discount columns 218A, 218B may result from membership of the customer in a corresponding customer loyalty program.

In some embodiments, the comparison table 208 additionally includes a donation amount 224A, 224B from at least one of the plurality of merchants to an entity associated with a corresponding merchant donation program. In the illustrated embodiment, both Merchant1 and Merchant2 belong to the same merchant donation program in which $0.05 of every dollar is donated to a merchant donation program generically identified in the comparison table 208 as “Donation Program.” In other embodiments, Merchant1 and Merchant2 may belong to different merchant donation programs and/or to no merchant donation programs at all, in which case the comparison table 208 may be adapted accordingly. Moreover, in practice, the comparison table 208 may identify a particular charity or other entity, such as the “Susan G. Komen Foundation” or a local school, to which the corresponding donation amount is committed in place of the generic “Donation Program” in FIG. 2B.

As described herein, the shopping list application 110 is configured to generate the comparison table 208. Accordingly, the shopping list application 110 may be configured to simultaneously compare pricing for multiple items at each of multiple merchants. Alternately or additionally, the shopping list application 110 may be configured to search for manufacturer's coupons and other discounts, merchant discounts, and/or other discounts and to simultaneously offer such discounts (e.g., by including them in the comparison table 208) to the customer.

Additionally, by including the total costs 220A, 220B per merchant in the comparison table 208, the customer may determine at a glance which merchant will provide the most cost savings and thus which of the merchants to patronize. Optionally, inclusion of the donation amounts 224A, 224B may inform the customer's decision of which of the two merchants to patronize. For instance, if one of the merchants participates in a merchant donation program that the customer feels strongly about and another of the merchants does not, the customer may decide to patronize the merchant that participates in the merchant donation program even though the total cost may be relatively higher.

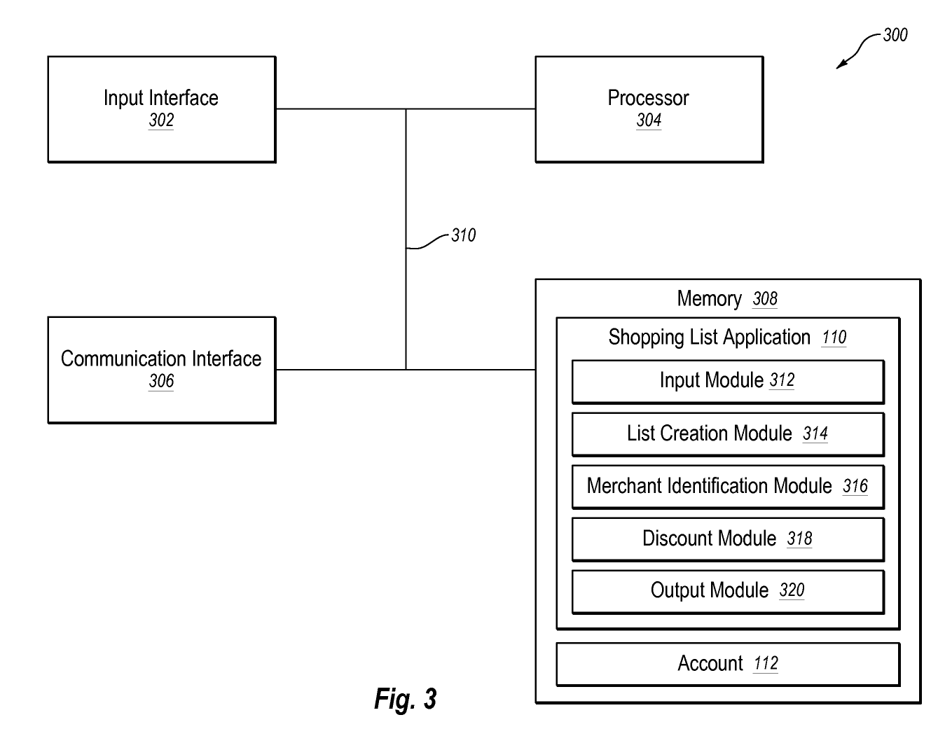

FIG. 3 is a block diagram of an example system 300 of pricing a shopping list, arranged in accordance with at least one embodiment described herein. The system 300 may correspond to the computing device 104 and/or the server 106 of FIG. 1. For example, the system 300 may include hardware components of one or both of the computing device 104 and the server 106. As illustrated, the system 300 includes the shopping list application 110 with various components which may be provided entirely to or divided between one or both of the computing device 104 and the server 106, as already mentioned above.

The system 300 may include an input interface 302, a processor 304, and a communication interface 306. In some embodiments, the system 300 may further include a memory 308 or other tangible computer-readable storage medium. The input interface 302, the processor 304, the communication interface 306, and the memory 308 may be communicatively coupled via a communication bus 310. The communication bus 310 may include, but is not limited to, a memory bus, a storage interface bus, a bus/interface controller, an interface bus, or the like or any combination thereof.

The input interface 302 may be configured to receive input identifying multiple different items, which items may be added to a shopping list, such as the shopping list 202 of FIGS. 2A-2B. Alternately or additionally, the input interface 302 may be configured to receive input identifying one or more discounts. Accordingly, the system 300 may further include an input device such as a keyboard, a mouse, a camera, or the like, that is configured to receive the discounts or data representing the discounts. In some embodiments, the input interface 302 may include one or more peripheral interfaces, such as a serial interface controller and/or a parallel interface controller, which may be configured to communicate with external devices such as input devices (e.g., keyboard, mouse, camera, pen, voice input device, touch input device, etc.) or other peripheral devices (e.g., printer, scanner, etc.).

The processor 304 may be configured to execute computer instructions that cause the system 300 to perform the functions and operations described herein, such as generating a shopping list including multiple items based on the input received by the input interface 302, identifying pricing data for the items at each of multiple different merchants, generating a comparison table, including a price comparison of the shopping list between the different merchants, and/or performing other functions described herein with respect to the shopping list application 110. The processor 304 may include, but is not limited to, a processor, a microprocessor (μP), a controller, a microcontroller (μC), a central processing unit (CPU), a digital signal processor (DSP), any combination thereof, or other suitable processor.

The communication interface 306 may be configured to facilitate communications over a network, such as the network 102 of FIG. 1, between the system 300 and other systems, users, and/or processes, such as the pricing data sources 108 of FIG. 1. For instance, the processor 304 may query the network 102, and more particularly the pricing data sources 108, through the communication interface 306 to identify pricing data of the different items included in the shopping list. In these and other embodiments, the communication interface 306 may include, but is not limited to, a network interface card, a network adapter, a local area network (LAN) adapter, or other suitable communication interface.

Computer instructions may be loaded into the memory 308 for execution by the processor 304. For example, the computer instructions may be in the form of the shopping list application 110 and/or its various modules. Execution of the shopping list application 110 and/or its various modules by the processor 304 may cause the system 300 to perform the functions and operations as described herein. In some embodiments, data generated, received, and/or operated on during performance of the functions and operations, such as the pricing data 206 of FIG. 2B, may be at least temporarily stored in the memory 308. Alternately or additionally, the account 112 associated with the customer may be stored, at least temporarily, in the memory 308. Moreover, the memory 308 may include volatile storage such as random access memory (RAM) or other suitable storage.

As illustrated in FIG. 3, the shopping list application 110 may include an input module 312, a list creation module 314, a merchant identification module 316, a discount module 318, and an output module 320. Some of the modules 312, 314, 316, 318, 320 may be provided on the computing device 104 of FIG. 1, while others of the modules 312, 314, 316, 318, 320 may be provided on the server 106 of FIG. 1. Alternately or additionally, all of the modules 312, 314, 316, 318, 320 may be provided on one or each of the computing device 104 and the server 106.

The input module 312 may be configured to receive and/or organize the input received via the input interface 302. In some embodiments, the input includes or identifies particular items to include in a shopping list, data identifying one or more customer loyalty programs to which the customer belongs, data identifying one or more merchant donation programs and/or the particular entity that benefits from the merchant donation program and which the customer is interested in patronizing, one or more coupons or other discounts obtained by the customer, or the like or any combination thereof. Alternately or additionally, the input module 312 may receive location data indicating a location of the customer. The location data may be input by the customer, e.g., by entering a zip code or the like, and/or may be received from a GPS or other location-aware device that is included in or separate from the system 300.

The list creation module 314 may be configured to generate a shopping list from the input received and/or organized by the input module 312. Alternately or additionally, the list creation module 314 may guide a customer through a process of generating a shopping list, including prompting the customer to select items from a list, to scan barcodes of desired items, or to otherwise identify particular items to include in the shopping list.

The merchant identification module 316 may be configured to identify two or more merchants and/or corresponding merchant locations. For example, the merchant identification module 316 may identify two or more merchant locations, each corresponding to a different one of two or more merchants, that are located within a predetermined distance from a location indicated by location data received by the input module 312. Alternately or additionally, the merchant identification module 316 may be configured to prompt the customer to input the location data and/or to select the two or more merchants and/or the corresponding merchant locations.

The discount module 318 may be configured to query a network, or more particularly, one or more pricing data sources, for pricing data. The network and the pricing data sources may respectively include the network 102 and the pricing data sources 108 of FIGS. 1-2A. The query may take into account the merchant locations identified by the merchant identification module 316. For instance, the discount module 318 may query the merchant sites 108B of FIGS. 1-2A for location-specific unit costs and/or merchant discounts corresponding to the identified merchant locations. The discount module 318 may additionally be configured to query the account 112 for any relevant pricing data and/or to query the network for customer loyalty program or merchant donation program information associated with each of the identified merchants/merchant locations.

The output module 320 may be configured to generate a comparison table based on the pricing data collected by the discount module 318. An example of such a comparison table is disclosed in FIG. 2B as described herein. In general, the output module 320 may populate the comparison table with the shopping list of items, a corresponding quantity of each item, corresponding manufacturer's coupons, corresponding merchant discounts for each merchant location, corresponding unit cost for each merchant location, corresponding extended cost for each merchant, a total cost for all of the items at each merchant location, loyalty program savings at each merchant location, and/or a donation amount for a corresponding merchant donation program. The output module 320 may additionally be configured to output the comparison table to the customer.

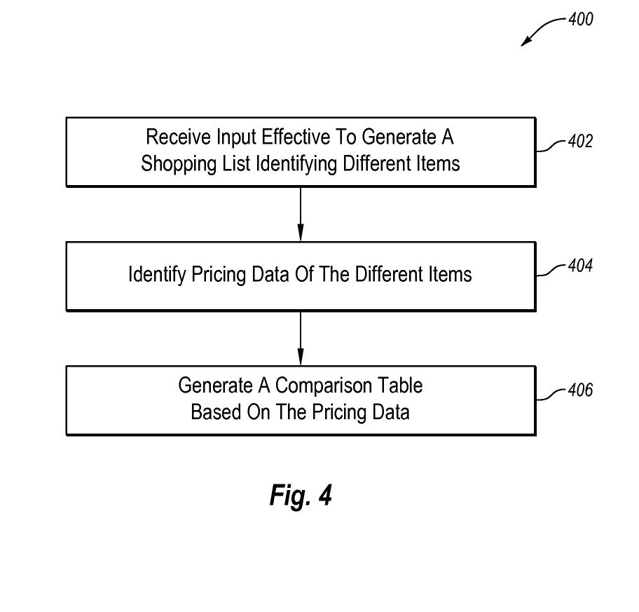

FIG. 4 shows an example flow diagram of a method 400 of pricing a shopping list, arranged in accordance with at least one embodiment described herein. The method 400 in some embodiments is performed by the system 300 of FIG. 3, which may include the computing device 104 and/or the server 106 of FIG. 1, e.g., by execution of the shopping list application 110. For instance, the processor 304 of FIG. 3 may be configured to execute computer instructions such as the shopping list application 110 to perform functions and operations for pricing a shopping list as represented by one or more of the blocks of the method 400 of FIG. 4. Although illustrated as discrete blocks, various blocks may be divided into additional blocks, combined into fewer blocks, or eliminated, depending on the desired implementation.

The method 400 may begin at block 402 in which input effective to generate a shopping list is received. The shopping list may identify multiple different items.

In block 404, pricing data of the different items is identified. The pricing data may include a unit cost of each of the different items at multiple different locations. Each of the different locations may be associated with a different one of multiple merchants and may thus be referred to as a merchant location as described above. The pricing data may additionally include discounts applicable to one or more of the items.

In some embodiments, identifying pricing data of the different items may include at least one of: searching one or more coupon websites on the network for discounts, including coupons associated with any of the different items; searching websites associated with manufacturers of the different items for discounts applicable to any of the different items; searching websites associated with the different merchants for a unit cost of each of the different items at the different locations; and searching the websites associated with the different merchants for discounts applicable to any of the different items at the different locations.

In block 406, a comparison table may be generated based on the pricing data. The comparison table may include a price comparison of the shopping list between the merchants. For example, as described with respect to FIG. 2B, the price comparison of the comparison table may include a unit cost of each of the different items in the shopping list at each of the different locations. The price comparison may additionally include an extended cost of each of the different items in the shopping list; the extended cost for each item may be based at least in part on a quantity of the item and a unit cost of the item.

Alternately or additionally, the price comparison may include a total cost to purchase all of the different items in the shopping list at each of the different locations. For instance, the comparison table 208 of FIG. 2B includes the total cost 220A, 220B at each of Merchant1 and Merchant2. In these and other embodiments, the price comparison may further include a donation amount from at least one of the merchants to an entity associated with a corresponding merchant donation program.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In some embodiments, some or all of the method 400 may be performed by a mobile device, such as by the computing device 104 of FIG. 1 implemented as a mobile device. In these and other embodiments, the method 400 may further include receiving location information identifying a location of the mobile device. The method 400 may further include selecting the different locations each associated with a different one of the merchants by identifying merchants having locations within a predetermined distance of the location of the mobile device.

Alternately or additionally, the shopping list may be associated with a customer. For example, the customer may provide input effective to generate the shopping list. In these and other embodiments, the method 400 may further include determining that the customer is a member of a customer loyalty program associated with one of the merchants. The identified pricing data for the one of the merchants may reflect the membership of the customer in the customer loyalty program.

Alternately or additionally, the method 400 may further include receiving one or more coupons from the customer. The coupons may be stored in an account associated with the customer, such as the account 112 described herein. In these and other embodiments, identifying pricing data of the different items identified in the shopping list may include searching the account associated with the customer for any coupons applicable to any of the different items identified in the shopping list.

Some embodiments described herein include an article of manufacture such as a tangible computer-readable storage medium having computer instructions stored thereon that are executable by a computing device to perform one or more of the operations included in the method 400 of FIG. 4, such as the operations illustrated by blocks 402, 404, and/or 406 in FIG. 4, and/or variations thereof. The tangible computer-readable storage medium may include the memory 308 of FIG. 3, for example. The computing device may include the computing device 104 of FIG. 1, the server 106 of FIG. 1, and/or the processor 304 of FIG. 3, for example.

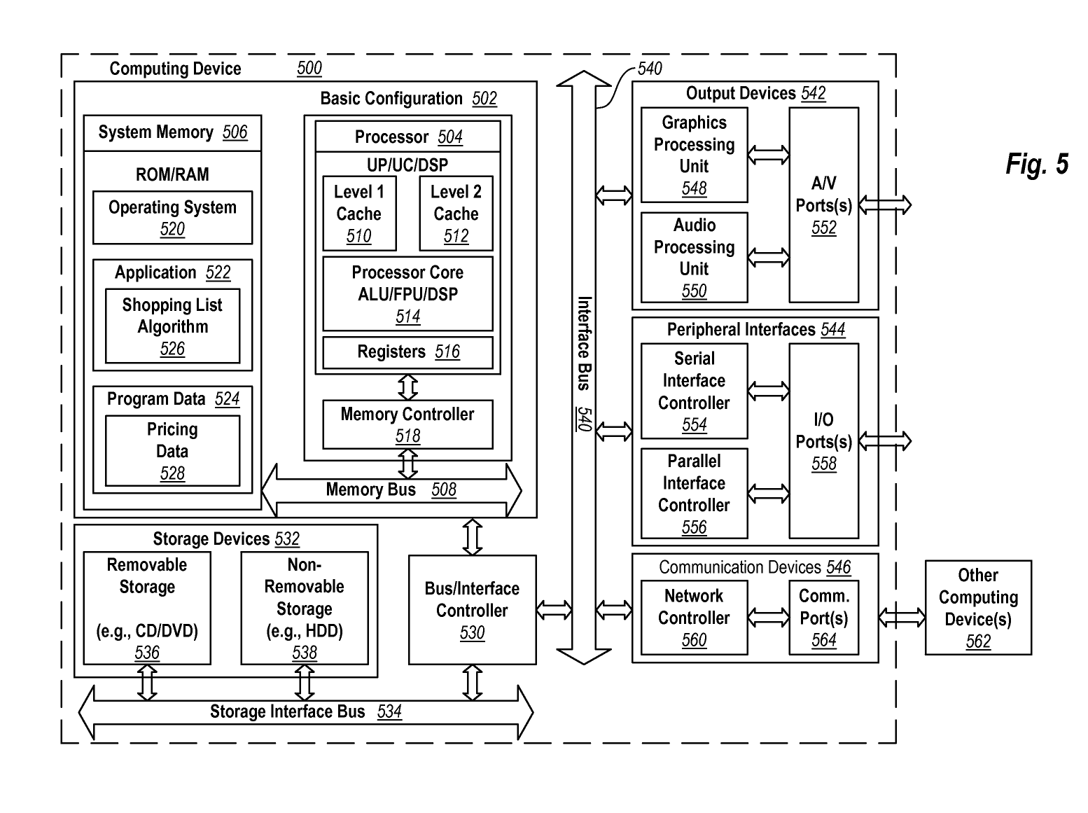

FIG. 5 is a block diagram illustrating an example computing device 500 that is arranged for pricing a shopping list, in accordance with at least one embodiment described herein. The computing device 500 may be included in or correspond to the computing device 104 of FIG. 1, the server 106 of FIG. 1, and/or the system 300 of FIG. 3, for example. In basic configuration 502, the computing device 500 typically includes one or more processors 504 and a system memory 506. A memory bus 508 may be used for communicating between the processor 504 and the system memory 506.

Depending on the desired configuration, the processor 504 may be of any type including, but not limited to, a μP, a controller, a μC, a CPU, a DSP, any combination thereof, or other suitable processor. The processor 504 may correspond to the processor 304 of FIG. 3. The processor 504 may include one or more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including, but not limited to, volatile memory (such as RAM), non-volatile memory (such as ROM, flash memory, etc.), or any combination thereof. The system memory 506 may include an OS 520, one or more applications 522, and program data 524. The application 522 may include a shopping list application 526 that is arranged to perform one or more of the functions as described herein, including those described with respect to the methods 200 and/or 400 of FIGS. 2 and 4. The program data 524 may include pricing data 528 that may be used as described above to price a shopping list of multiple items for multiple merchants and/or merchant locations. In some embodiments, the application 522 may be arranged to operate with the program data 524 on the OS 520 such that implementations of methods of pricing a shopping list such as the methods 200 and 400 of FIGS. 2 and 4 may be provided as described herein.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and non-volatile, removable and non-removable media implemented in any method or technology for storage of information, such as computer-readable instructions, data structures, program modules, or other data.

The system memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via the bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 500 may also be implemented as a personal computer, including both laptop computer and non-laptop computer configurations.

All examples and conditional language recited herein are intended for pedagogical objects to aid the reader in understanding the invention and the concepts contributed by the inventor to furthering the art, and are to be construed as being without limitation to such specifically-recited examples and conditions. Although embodiments of the present inventions have been described in detail, it should be understood that the various changes, substitutions, and alterations could be made hereto without departing from the spirit and scope of the invention.

What is claimed is:

1. A method of pricing a shopping list, the method comprising:
receiving, by a processor, input effective to generate a shopping list identifying a plurality of different items;
identifying, by a processor, pricing data of the plurality of different items, the pricing data including:
a unit cost of each of the plurality of different items at a plurality of different locations, each of the plurality of different locations being associated with a different one of a plurality of merchants; and
discounts applicable to one or more of the plurality of different items; and
generating, by a processor, a comparison table based on the pricing data, the comparison table including a price comparison of the shopping list between the plurality of merchants.

2. The method of claim 1, wherein the discounts applicable to one or more of the plurality of different items include or are associated with at least one of a coupon, a rebate, a sale, or a special offer.

3. The method of claim 1, wherein the price comparison of the shopping list between the plurality of merchants includes:
a unit cost of each of the plurality of different items at each of the plurality of different locations; and
an extended cost of each of the plurality of different items, the extended cost for each item being based at least in part on a quantity of the item and a unit cost of the item.

4. The method of claim 3, wherein the extended cost for each item is calculated according to EC=QTY×UC−D, where EC is the extended cost, QTY is the quantity of the item, UC is the unit cost of the item, and D is a discount, if any, applicable to the item.

5. The method of claim 1, wherein the price comparison of the shopping list between the plurality of merchants includes a total cost to purchase all of the plurality of different items in the shopping list at each of the plurality of different locations.

6. The method of claim 5, wherein the price comparison of the shopping list between the plurality of merchants further includes a donation amount from at least one of the plurality of merchants to an entity associated with a corresponding merchant donation program.

7. The method of claim 1, wherein identifying pricing data of the plurality of different items includes any one of:
searching one or more coupon websites on the network for discounts including coupons associated with any of the plurality of different items;
searching websites associated with manufacturers of the plurality of different items for discounts applicable to any of the plurality of different items;
searching websites associated with the plurality of different merchants for a unit cost of each of the plurality of different items at the plurality of different locations; and
searching the websites associated with the plurality of different merchants for discounts applicable to any of the plurality of different items at the plurality of different locations.

8. The method of claim 1, wherein the method is performed by a mobile device, the method further comprising:
receiving location information identifying a location of the mobile device; and
selecting the plurality of different locations each associated with a different one of the plurality of merchants by identifying merchants having locations within a predetermined distance of the location of the mobile device.

9. The method of claim 1, wherein the shopping list is associated with a customer, the method further comprising determining that the customer is a member of a customer loyalty program associated with one of the plurality of merchants, wherein the identified pricing data for the one of the plurality of merchants reflects the membership of the customer in the customer loyalty program.

10. The method of claim 1, wherein the shopping list is associated with a customer, the method further comprising:
receiving one or more coupons from the customer; and
storing the one or more coupons in an account associated with the customer,
wherein identifying pricing data of the plurality of different items includes searching the account associated with the customer for any coupons applicable to any of the plurality of different items identified in the shopping list.

11. A tangible computer-readable storage medium having computer instructions stored thereon that are executable by a computing device to perform the method of claim 1.

12. A system of pricing a shopping list, the system comprising:
an input interface configured to receive input identifying a plurality of different items;
a processor communicatively coupled to the input interface and configured to generate a shopping list identifying the plurality of different items; and
a communication interface communicatively coupled to the processor, the processor being further configured to query a network through the communication interface to identify pricing data of the plurality of different items, the pricing data including:
a unit cost of each of the plurality of different items at a plurality of different locations, each of the plurality of different locations being associated with a different one of a plurality of merchants; and
discounts applicable to one or more of the plurality of different items;
the processor being further configured to generate a comparison table based on the pricing data, the comparison table including a price comparison of the shopping list between the plurality of merchants.

13. The system of claim 12, wherein the discounts applicable to one or more of the plurality of different items include or are associated with at least one of a coupon, a rebate, a sale, or a special offer.

14. The system of claim 12, wherein the price comparison of the shopping list between the plurality of merchants includes:
a unit cost of each of the plurality of different items at each of the plurality of different locations; and
an extended cost of each of the plurality of different items, the extended cost for each item being based at least in part on a quantity of the item and a unit cost of the item.

15. The system of claim 14, wherein the extended cost for each item is calculated according to EC=QTY×UC−D, where EC is the extended cost, QTY is the quantity of the item, UC is the unit cost of the item, and D is a discount, if any, applicable to the item.

16. The system of claim 12, wherein the price comparison of the shopping list between the plurality of merchants includes a total cost to purchase all of the plurality of different items in the shopping list at each of the plurality of different locations.

17. The system of claim 16, wherein the price comparison of the shopping list between the plurality of merchants further includes a donation amount from at least one of the plurality of merchants to an entity associated with a corresponding merchant donation program.

18. The system of claim 12, wherein the processor is configured to query the network through the communication interface to identify pricing data of the plurality of different items by any one of:
searching one or more coupon sources on the network for discounts including coupons associated with any of the plurality of different items;
searching websites associated with manufacturers of the plurality of different items for discounts applicable to any of the plurality of different items;
searching websites associated with the plurality of different merchants for a unit cost of each of the plurality of different items at the plurality of different locations; and
searching the websites associated with the plurality of different merchants for discounts applicable to any of the plurality of different items at the plurality of different locations.

19. The system of claim 12, wherein:
the shopping list is associated with a customer;
the processor is further configured to determine that the customer is a member of a customer loyalty program associated with one of the plurality of merchants; and
the identified pricing data for the one of the plurality of merchants reflects the membership of the customer in the customer loyalty program.

20. The system of claim 12, wherein the shopping list is associated with a customer, the system further comprising:
an input device configured to receive one or more coupons from the customer; and
a tangible computer-readable storage medium configured to store the one or more coupons in an account associated with the customer,
wherein the processor is further configured to identify pricing data by searching the account associated with the customer for any coupons applicable to any of the plurality of different items identified in the shopping list.
